(19) United States
(12) Patent Application Publication
(10) Pub. No.: US 2023/0015693 A1
(43) Pub. Date: Jan. 19, 2023

(54) RESTORATION OF CORRUPTED KEYS IN A SECURE STORAGE SYSTEM

(71) Applicant: HARMAN INTERNATIONAL INDUSTRIES, INCORPORATED, Stamford, CT (US)

(72) Inventors: Asadullah ANSARI, Karnataka (IN); Sharath Yadav Doddamane HEMANTHARAJA, Karnataka (IN)

(21) Appl. No.: 17/860,976

(22) Filed: Jul. 8, 2022

(30) Foreign Application Priority Data
Jul. 9, 2021 (IN) 202141030887

(51) Int. Cl. H04L 9/08; H04L 9/32

(52) U.S. Cl. CPC H04L 9/0894; H04L 9/0891; H04L 9/3268

(57) ABSTRACT

Various embodiments include techniques for recovering a cryptographic key in a system that includes secure storage. A computer system implementing these techniques determines that the cryptographic key stored in a first secure storage is corrupted. The computer system retrieves an emergency key from a second secure storage. The computer system establishes communications with a server by using the emergency key.

### CROSS-REFERENCE TO RELATED APPLICATIONS

This application claims priority benefit of the Indian Provisional Patent Application titled, “Restoration of Corrupted Keys in a Secure Storage System,” filed on Jul. 9, 2021, and having Serial No. 202141030887. The subject matter of this related application is hereby incorporated herein by reference.

### BACKGROUND

### Field of the Various Embodiments

The various embodiments relate generally to vehicle computer systems and, more specifically, to techniques for restoration of corrupted keys in a secure storage system.

### Description of the Related Art

Many modern vehicles rely on sophisticated electronics systems for various operational and safety functions, including engine performance, information and entertainment (also referred to as infotainment), autonomous or semiautonomous driving, collision avoidance, route navigation, and/or the like. These modern-day vehicles often employ techniques in order to avoid inadvertent, intentional, and/or malicious alteration and control of these electronics systems, such as cyberattacks and other related activities. To that end, vehicles typically have a secure storage system, such as a non-volatile memory system, that stores various cryptographic keys associated with an engine control unit (ECU) of the vehicle and/or other electronic systems in the vehicle. The ECU and/or other electronic systems in the vehicle use cryptographic keys for various cryptographic verifications. These cryptographic verifications include establishing communications with various in-vehicle devices, with other nearby vehicles, with other external devices, and/or the like. Corruption of the secure storage can result in one or more cryptographic keys being unavailable in the secure storage. When the ECU and/or other electronic systems in the vehicle determine that a cryptographic key has been corrupted, the ECU and/or other electronic systems can interrupt communications associated with various vehicular services. As a result, corrupted cryptographic keys can result in lower performance and/or functionality of the vehicle.

One potential solution to the problem of corrupted cryptographic keys is to recall compromised vehicles to a service center at the manufacturing plant, an authorized service provider, and/or the like for reprovisioning. When the ECU and/or other electronic systems of a vehicle encounters a corrupted cryptographic key, a message can be displayed on a display of the vehicle that the vehicle needs to be serviced. After the owner or driver brings the vehicle in to be serviced, the service center can manually recover the original cryptographic keys and reprovision the vehicle with the original cryptographic keys. After reprovisioning, the various electronic systems of the vehicle can again operate normally. Even though this technique is generally successful, recalling vehicles for service and reprovisioning corrupted cryptographic keys can be relatively costly in terms of both time and money. The driver and/or owner needs to arrange for a service, and the service center needs to reserve time to reprovision the cryptographic keys. In the aggregate, this potential solution to the problem of corrupted cryptographic keys can pose significant costs for the service centers to recall the affected vehicles and to reprovision the corrupted keys. In addition, this technique is a time-consuming process for the driver and/or owner of the vehicle.

As the foregoing illustrates, improved techniques for recovering corrupted cryptographic keys of a vehicle would be useful.

### SUMMARY

Various embodiments of the present disclosure set forth a computer-implemented method for recovering a cryptographic key in a system that includes secure storage. The method includes determining that the cryptographic key stored in a first secure storage is corrupted. The method further includes retrieving an emergency key from a second secure storage. The method further includes. The method further includes establishing communications with a server by using the emergency key.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, a vehicle in the field can restore corrupted cryptographic keys stored in the secure storage system of the vehicle. The vehicle can restore the corrupted cryptographic keys without returning the vehicle to the manufacturing plant, an authorized service provider, or other service center. As a result, service centers do not need to reserve shop capacity to restore corrupted cryptographic keys. Further, drivers and owners can reduce the time and number of service calls for their vehicles. The disclosed embodiments thereby present techniques to perform recovery of cryptographic keys resulting from a corrupted secure storage without recalling the vehicles back into the service center. By avoiding recall of vehicles with corrupted cryptographic keys, the disclosed techniques reduce the time and financial burden of service centers and of drivers and owners of affected vehicles. These advantages represent one or more technological improvements over prior art approaches.

### BRIEF DESCRIPTION OF THE DRAWINGS

So that the manner in which the recited features of the one or more embodiments set forth above can be understood in detail, a more particular description of the one or more embodiments, briefly summarized above, may be had by reference to certain specific embodiments, some of which are illustrated in the appended drawings. It is to be noted, however, that the appended drawings illustrate only typical embodiments and are therefore not to be considered limiting of its scope in any manner, for the scope of the various embodiments subsumes other embodiments as well.

FIG. 1 is a block diagram of a vehicle-based computer system configured to implement one or more aspects of the various embodiments.

FIG. 2 illustrates various digital services that can be implemented by the vehicle-based computer system of FIG. 1 according to one or more aspects of the various embodiments.

FIG. 3 is a block diagram of a cloud-based service network for the vehicle-based computer system of FIG. 1 according to one or more aspects of the various embodiments.

FIG. 4 is a block diagram of operations to install cryptographic keys in the secure storage of the vehicle-based computer system of FIG. 1 by a provisioning system based at a service center according to one or more aspects of the various embodiments.

FIG. 5 is a block diagram of operations to recover corrupted cryptographic keys in the secure storage of the vehicle-based computer system of FIG. 1 by a key recovery system according to one or more aspects of the various embodiments.

FIGS. 6A-6B set forth a flow diagram of method steps for provisioning cryptographic keys in the secure storage of the vehicle-based computer system of FIG. 1 according to one or more aspects of the various embodiments.

FIG. 7 is a flow diagram of method steps for recovering corrupted cryptographic keys in the secure storage of the vehicle-based computer system of FIG. 1 according to one or more aspects of the various embodiments.

### DETAILED DESCRIPTION

Among other things, the disclosed embodiments are directed to a vehicle-based computer system with secure storage. The vehicle-based computer system has an embedded system that includes remotely operable vehicle firmware, in-vehicle communications, one or more processors, and/or the like. The vehicle-based computer system can be included in a vehicle digital cockpit, a head unit, an advanced driver assistance system (ADAS), an ECU, and/or the like. The functionality of the vehicle-based computer system typically resides as firmware stored in a non-volatile memory.

In various embodiments, the vehicle-based computer system recovers cryptographic keys when one or more cryptographic keys stored in secure storage become corrupt. Cryptographic keys can be corrupted, for example, due to inadvertent, intentional, and/or malicious alteration. Such corrupted cryptographic keys can result in the inability of the vehicle-based computer system to retrieve keys from the secure storage, rendering the vehicle-based computer system unable to perform one or more digital services for the vehicle. More specifically, the corruption of cryptographic keys in secure storage can result in the failure to establish a communications connection between the vehicle-based computer system and cloud services external to the vehicle, which in turn causes the failure of various digital services. These digital services that are subject to failure include any one or more of downloading navigation maps from a cloud service, over the air (OTA) functionality for software downloads and updates, digital cryptographic key authentication, accessing web applications via a cloud service, and/or the like.

Conventional solutions to recover the corrupted cryptographic keys from the secure storage involve recalling vehicles to a service center and manually reprovisioning the keys. This process can be costly and time-consuming for both the service centers and the drivers and owners of the affected vehicles. By contrast, the disclosed embodiments protect the above vehicular digital cockpit functionalities even when the cryptographic keys stored in the secure storage are corrupted by providing an automated cryptographic key recovery mechanism. With the disclosed techniques, cryptographic keys that have been corrupted can be recovered by the vehicle without recalling the vehicle to a service center.

### System Overview

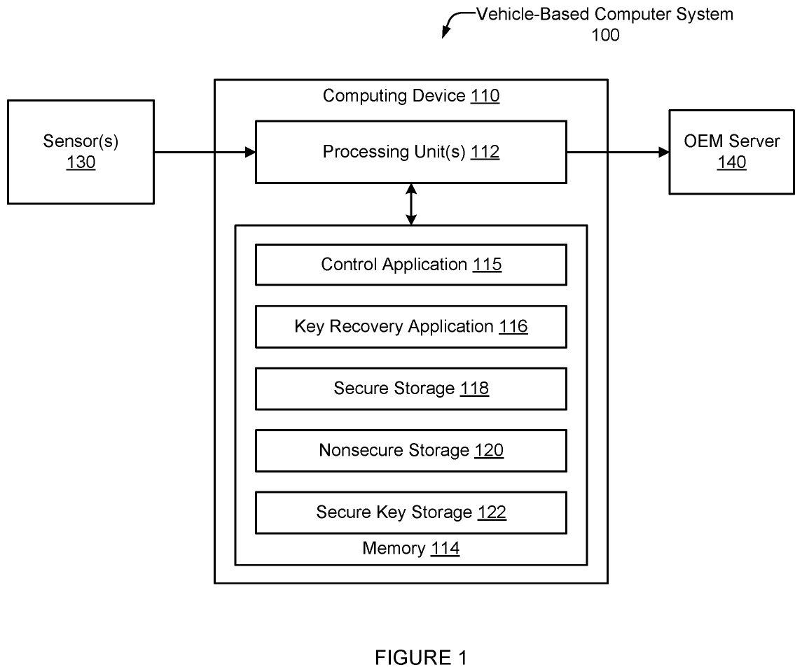

FIG. 1 is a conceptual block diagram of a vehicle-based computer system 100 configured to implement one or more aspects of the various embodiments. As shown, the vehicle-based computer system 100 includes, without limitation, a computing device 110 in communication with one or more original equipment manufacturer (OEM) servers 140.

Computing device 110 includes, without limitation, processing unit(s) 112, memory 114, and sensor(s) 130. Memory 114 includes a control application 115, a key recovery application 116, secure storage 118, nonsecure storage 120, and secure key storage 122. Vehicle-based computer system 100 receives data from various sensor(s) 130 included in the vehicle. Vehicle-based computer system 100 can be embedded into a vehicle digital cockpit, a head unit, an ADAS, an ECU, and/or other component included in a vehicle.

Sensor(s) 130 can include any type of device that is capable of receiving and/or transmitting sensor data, including accelerometer data, angular velocity data, and so forth. In some embodiments, sensor(s) 130 include one or more sensors that provide other data, such as location data, image data, temperature data, fluid level data, braking data, proximity data, and/or the like. Non-limiting examples of sensor(s) 130 include accelerometers, gyroscopes, computing devices, smartphones, navigation devices, imaging devices, Internet of Things (IoT) devices, radiofrequency identification (RFID) devices, traffic devices, global positioning devices, temperature sensors, pressure transducers, etc. In various embodiments, sensor(s) 130 communicates with computing device 110 via wired and/or wireless connections.

As noted above, computing device 110 includes one or more processing unit(s) 112 and memory 114. Computing device 110 can be a device that includes one or more processing units 112, such as a system-on-a-chip (SoC). Generally, computing device 110 can be configured to coordinate the overall operation of vehicle-based computer system 100. The embodiments disclosed herein contemplate any technically feasible system configured to implement the functionality of vehicle-based computer system 100 via computing device 110. Computing device 110 communicates with OEM server 140 via wired and/or wireless connections. In some embodiments, computing device 110 establishes communications with OEM server 140 via a communications channel, such as a transport level security (TLS) layer. As described herein, OEM server 140 provides one or more digital services for the vehicle. These digital services include any one or more of downloading navigation maps from a cloud service, over the air (OTA) functionality for software downloads and updates, digital cryptographic key authentication, accessing web applications via a cloud service, and/or the like. Computing device 110 can be located in various environments including, without limitation, road vehicle environments (e.g., consumer vehicle, commercial truck, etc.), aerospace and/or aeronautical environments (e.g., airplanes, helicopters, spaceships, etc.), nautical and submarine environments, and so forth.

Processing unit(s) 112 can be any technically feasible form of processing device configured to process data and execute program code. Processing unit(s) 112 could include, for example, and without limitation, a system-on-chip (SoC), a central processing unit (CPU), a graphics processing unit (GPU), an application-specific integrated circuit (ASIC), a digital signal processor (DSP), a field-programmable gate array (FPGA), and so forth. Processing unit(s) 112 includes one or more processing cores. In operation, processing unit 112 can be a primary processor of computing device 110, controlling and coordinating operations of other system components.

Memory 114 can include a memory module or a collection of memory modules. In various embodiments, processing unit(s) 112 executes control application 115 to implement the overall functionality of the computing device 110 and, thus, to coordinate the operation of the vehicle-based computer system 100 as a whole. For example, and without limitation, sensor data acquired via the sensors 130 can be processed by control application 115 to generate commands to control various digital services of the vehicle. Processing unit(s) 112, when executing control application 115 can access secure storage 118, nonsecure storage 120, and/or secure key storage 122. When generating commands for various digital services, control application 115 accesses various cryptographic keys stored in secure storage 118 to verify whether the cryptographic keys are corrupt. If the cryptographic keys are not corrupt, then control application 115 continues to generate commands to control various digital services of the vehicle. If one or more cryptographic keys are corrupt, then processing unit 112 executes key recovery application 116 to recover cryptographic keys that have been corrupted.

By executing control application 115 and key recovery application 116, processing unit 112 provides various digital services that enhance vehicle performance and improve the experience of the driver and passengers. Processing unit 112 accesses OEM server 140 via a connected vehicle cloud infrastructure to provide safety, security, entertainment, and communication related services to the vehicle in real-time. This vehicular connection between processing unit 112 and OEM server 140 is established through a secure TLS or other secure connection. The cryptographic keys used for certificate verifications for the successful establishment of the secure connection between processing unit 112 and OEM server 140 are stored in secure storage 118. Any corruption of secure storage 118, either due to security breaches or other activities, can result in the cryptographic keys becoming inaccessible or having a modified value. This condition results in a corrupted cryptographic key in secure storage 118. Such cryptographic key corruption can result in failure of security certificate verifications. Failure to verify a security certificate can lead to a failure to establish a secure connection between processing unit 112 and OEM server 140, resulting in the denial of digital services. Consequently, the vehicle is no longer able to supply these digital services.

System designs support security goals with different approaches, depending on the type and value of the assets the system is trying to protect. In general, secure system designs protect against subsets of possible attacks. Further, multiple security solutions can be combined to increase the likelihood that the system design is secure from attacks. In that regard, computing device 110 can implement secure storage 118 in combination with other security techniques, such as write protection, password lock/unlock, write protect, and/or the like.

The disclosed embodiments include an automated key recovery technique that recovers the corrupted cryptographic keys stored in secure storage 118 using a software update process in the form of an emergency key recovery service. The key recovery technique employs two cryptographic keys. The main cryptographic key is stored in secure storage 118. The secondary cryptographic key is stored in a different location, such as another portion of secure storage 118, in a non-volatile memory included in processing unit 112, in a controller (not shown) that is separate from computing device 110, and/or the like. In some examples, the secondary cryptographic key is stored in a memory system included in an input/output controller (IoC) associated with a hardware security module (HSM). This secondary cryptographic key is considered as an emergency key. Both the main cryptographic key and the secondary cryptographic key are provisioned and installed into computing device 110 during manufacturing of the vehicle-based computer system 100. During normal operation, control application 115 accesses the main cryptographic key that is stored in secure storage 118 in order to initiate and maintain communications with OEM server 140 and to provide digital services for the vehicle. If control application 115 determines that the main cryptographic key stored in secure storage 118 has been corrupted, then key recovery application 116 accesses the secondary cryptographic key as an emergency key to establish a secure connection between processing unit 112 and OEM server 140.

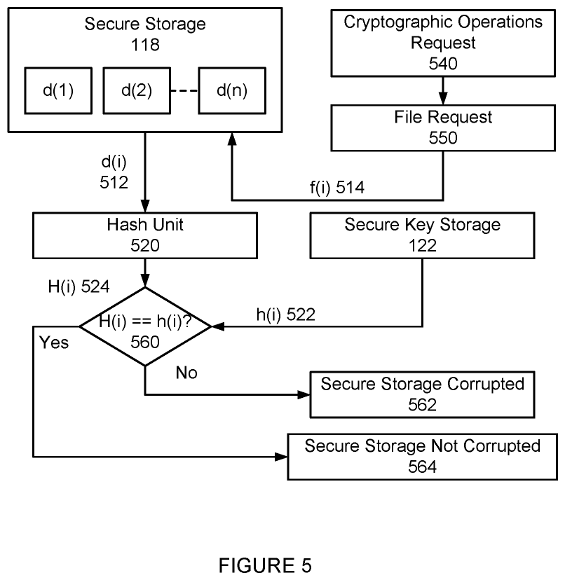

Control application 115 determines that the main cryptographic key stored in secure storage 118 has been corrupted using the operations described in conjunction with FIG. 5. As described herein, control application 115 generates a cryptographic operations request. The cryptographic operations request verifies a cryptographic key by accessing a set of data in stored in secure storage 118 that contains the cryptographic key. Control application 115 generates a hash value from this data and compares the generated hash value with a stored hash value that was previously generated from the same data. If the two hash values are equal, then the cryptographic key is not corrupted and the cryptographic operations complete successfully. If the two has values are not equal, then the cryptographic key is corrupted. In such cases, control application 115 invokes key recovery application 116 to establish a secure connection with OEM server 140. In some embodiments, key recovery application 116 invokes an emergency service or an emergency session for the purpose of establishing a secure connection with OEM server 140 in order to recover the corrupted cryptographic key and/or perform operations for one or more digital services.

In some examples, control application 115 determines that the main cryptographic key stored in secure storage 118 has been corrupted by attempting to use the main cryptographic key to establish a secure connection with OEM server 140. If OEM server 140 transmits a message to vehicle-based computer system 100 that the main cryptographic key is rejected, then control application 115 considers the main cryptographic key to be corrupted.

Computing device 110 implements a security framework using both hardware and software to counter many threats in the vehicle-based computer system 100. This security framework partitions hardware resources and software resources into two environments—a secure environment for security subsystems and sensitive assets, and a standard environment for remaining applications. The secure environment and the standard environment each have an independent memory address space. The security framework ensures that no assets in the secure environment can be accessed from the standard environment. This isolation provides protection to trusted applications executing in the secure environment against non-trusted applications executing in the standard environment. In general, non-trusted applications are installed by end users and execute in the standard environment under the control of a standard operating system (OS). When the security framework is enabled, computing device 110 can switch between the secure mode and non-secure mode, thereby providing a secure environment when in secure mode and a standard environment when in secure mode. The secure environment and the standard environment execute with different privileges. Computing device 110 can apply a set of hardware extensions to ensure that resources (such as memory, interrupts, peripherals, and/or the like) are isolated between the secure mode and non-secure mode. The software executing in the secure mode executes with a higher privilege level and has access to both secure and non-secure resources. The software executing in the non-secure mode has access that is restricted to the non-secure resources.

Computing device 110 implements a trusted execution environment, which is a secure area within processing unit 112. The trusted execution environment executes in parallel with the operating system, in an isolated environment. The trusted execution environment ensures that software applications and data loaded in the trusted execution environment are protected with respect to the goals of confidentiality, integrity, and availability. The goal of confidentiality provides that information that should stay secret can be read and/or decoded only by authorized entities. Other users without access authorization cannot read and/or decode the confidential information. The goal of integrity provides the ability to ascertain that the information is protected from unauthorized alteration, modification, and/or deletion. Integrity of information covers the origin, completeness, and correctness of information using techniques such as identification and authentication. The goal of availability provides that the secure software applications and data loaded in the trusted execution environment has a high degree of availability and accessibility to the authorized users.

Secure storage 118 is a memory system that it is able to store protected general-purpose data and the main cryptographic keys that are accessible when is computing device 110 executing in a trusted execution environment. In some embodiments, the protected general-purpose data stored in secure storage 118 includes user profile data, instructions executed when operating in the trusted execution environment, data accessed when in the trusted execution environment, and/or the like. The main cryptographic keys ensure confidentiality and integrity of the operations executed by computing device 110 for one or more digital services. In addition, computing device 110 accesses the main cryptographic keys to authenticate and enable inter-device communications with devices internal to vehicle-based computer system 100, such as various sensors 130. Computing device 110 also accesses these main cryptographic keys to authenticate and enable inter-system communications with devices external to vehicle-based computer system 100, such as OEM server 140. Further, these main cryptographic keys ensure the atomicity of the operations that modify the data stored in secure storage 118. As used herein, atomicity refers to operations where an entire read-modify-write operation completes successfully and/or operations where no write is performed.

In some examples, secure storage 118 is implemented on a standard file system and secure storage 118 is enabled at compile time. Secure storage 118 can be implemented using any technically feasible approach for providing storage that is protected from unauthorized access. In some examples, secure storage 118 is implemented as a replay protected memory block (RPMB) partition of an embedded memory system. The RPMB protocol enables a device to store secure data in a confined, specific area of secure storage 118 that is authenticated and protected against replay attack. RPMB can be implemented in automotive ECUs and related controllers using flash storage technology such as embedded multimedia card (eMMC), universal flash storage (UFS), non-volatile memory express (NVMe), and/or the like.

RPMB is a self-contained security protocol with defined command opcodes and data structures. The mechanism for this protocol includes a shared cryptographic key and a hash message authentication code (HMAC), which is used to sign all the read/write operations accessing the secured area. The RPMB is a separated partition of memory designed for secure data storage and implemented on eMMC, UFS devices, NVMe, and/or the like. Because each access to RPMB must be authenticated, this separated partition of memory is engineered to be write protected from software entities that do not have access to the proper authentication key. This technique allows the RPMB device to defend against rollback or replay attack by storing versions or counts in this separated partition of memory. Access to RPMB is authenticated by an HMAC, which is a hash value generated in the trusted execution environment from an authentication key. This authentication key is generally provisioned to the eMMC, UFS device, or NVMe in the trusted execution environment before any access to RPMB is permitted. The RPMB secure storage technique can be used for software version authentication to prevent a downgrade attack prevention of unauthorized unlock secured boot and secured write protection, and/or the like.

In some examples, the RPMB secure storage partition is a fixed size partition in the range of 128 KB to 16 MB in a portion of an eMMC, UFS drive, NVMe device, and/or the like. The size of the RPMB secure storage partition cannot be changed after deployment. Typically, the RPMB authentication key is programmed into the RPMB controller in the eMMC, UFS device, or NVMe device and is programmed once. During programming, the RPMB key is sent with cleartext. Therefore, the RPMB key is typically provisioned in a safe environment, such as at the manufacturing plant, or in a trusted firmware environment in the field such as a service center. The RPMB key can be provisioned initially at the time of manufacture and/or after a failed eMMC, UFS device, or NVMe device is replaced with a new device. This RPMB secure storage can be used for anti-rollback during a verified boot sequence, for recording authentication retry attempt failures in order to prevent brute-force attacks, for storing credentials and/or confidential data, for storing OEM image encryption keys, and/or the like.

Nonsecure storage 120 is a memory system that it is able to store general-purpose data and client software applications that are accessible whether computing device 110 is executing in a trusted execution environment or is executing in a non-trusted (standard) execution environment. As such, when executing a client software application, computing device 110 accesses nonsecure storage 120 to read instructions include in the client software application and to read and write data on behalf of the client software application.

Secure key storage 122 is a memory system that it is able to store secondary cryptographic keys, also referred to emergency keys, and other related data. The secure key storage 122 is located in a non-volatile memory included in processing unit 112, in a separate controller (not shown), and/or the like. In some examples, secure key storage 122 is included in another portion of secure storage 118 that is isolated from the portion of secure storage 118 that stores the main cryptographic keys.

Typically, computing device 110 communicates via a connected vehicle cloud infrastructure in order to access numerous digital services for driver assistance, user entertainment, vehicular communications, software system enhancements, security purposes, and/or the like. Computing device 110 communicates via the connected vehicle cloud infrastructure over a secure (e.g., TLS) connection between vehicle-based computer system 100 and OEM server 140. TLS and other secure communications protocols are cryptographic protocols that allow secure and encrypted communication between a client software application executing on vehicle-based computer system 100 and OEM server 140. In addition to providing transport layer encryption, TLS also ensures data confidentiality over the connected vehicle cloud infrastructure.

Vehicle-based computer system 100 and OEM server 140 use security certificates to verify each other's identity and authenticity. This technique helps to prevent man-in-the-middle attacks. Via these security certificates, a sender of data can ensure that the receiver receives the same data as sent by the sender, and vice versa. The authenticity verification between vehicle-based computer system 100 and OEM server 140 occurs by utilizing the private encryption keys stored in secure storage 118 of the vehicle-based computer system 100 in order to establish a secure connection. Any compromise of these private encryption keys, which are stored into the secure storage 118 during the vehicle manufacturing by provisioning, results in the unavailability or modification of the private encryption keys. When corrupted private encryption keys are accessed for authentication between vehicle-based computer system 100 and OEM server 140, the vehicle-based computer system 100 is unable to establish a secure connection with OEM server 140. Therefore, the digital services which are activated upon establishment of a secure connection are denied. The private encryption keys stored in secure storage 118 can become corrupted due to multiple independent factors such as cyberattacks, secure storage corruption, private encryption key corruption, and/or the like.

In some examples, computing device 110 considers that the private encryption keys are deleted when a factory reset is completed. Therefore, if a bug or other software defect is identified, and a secure software update or secure software patch is downloaded and installed to address the bug or other software defect, the private encryption keys are no longer usable. As a result, critical data stored in secure storage 118, such as the cryptographic keys used for numerous cryptographic verifications in connected vehicles, is lost. The corruption of the cryptographic keys stored in secure storage 118 can cause the failure of numerous digital services in the connected vehicles. The failure of these numerous digital services is due to the inability to establish a secure connection between vehicle-based computer system 100 and OEM server 140.

The digital services that can be negatively impacted by corruption of the cryptographic keys stored in secure storage 118 include, without limitation, the following:
Communications with the driver connected to the vehicle via a human machine interface (HMI)
Map service cloud connected to the vehicle via long term evolution communication (LTE)
Infotainment content provider connected to the vehicle via LTE
OEM server 140 connected to the vehicle via LTE
Remote control connected to the vehicle via WiFi, Bluetooth low energy (BLE), and/or the like
Emergency and insurance services connected to the vehicle via LTE
Communications with other vehicles connected to the vehicle via vehicle to vehicle (V2V) communications
Communications with an infrastructure connected to the vehicle via vehicle to infrastructure (V2I) communications
Communications with pedestrians connected to the vehicle via vehicle to pedestrian (V2P) communications
Diagnostic tester connected to the vehicle via an on-board diagnostics (OBD) port

In some examples, corrupted cryptographic keys result in failure to download navigation maps from OEM server 140. Vehicle-based computer system 100 utilizes a navigation system for dynamic route planning of the autonomous system and/or driver assistance system. In this regard, vehicle-based computer system 100 downloads the navigation maps from OEM server 140 to use during offline processing in a fast and efficient manner. Vehicle-based computer system 100 downloads the navigation maps after the successful establishment of the secure connection between vehicle-based computer system 100 and OEM server 140. To establish a successful connection, vehicle-based computer system 100 accesses the cryptographic keys stored in secure storage 118 for cryptographic verification. Corruption of these stored cryptographic keys results in the failure in authentication between vehicle-based computer system 100 and OEM server 140 which, in turn, results in failure of vehicle-based computer system 100 to establish a connection with OEM server 140. As a result, vehicle-based computer system 100 is unable to download the navigation maps.

In some examples, corrupted cryptographic keys result in failure to download OTA software updates from OEM server 140 and install the OTA software updates in computing device 110. In modern vehicles, recall campaigns are often software-related, where the software in vehicle-based computer system 100 is to be updated, but no hardware or mechanical updates are needed. In such case, vehicle-based computer system 100 can perform a software update over the air, resulting in cost savings by avoiding a physical recall of the affected vehicles. Vehicle-based computer system 100 performs such an OTA update in the field after establishing a trusted connection between vehicle-based computer system 100 and OEM server 140. Corrupted cryptographic keys stored in secure storage 118 results in the failure of vehicle-based computer system 100 to establish a secure connection with OEM server 140, which in turn causes failure of the OTA software update.

In some examples, corrupted cryptographic keys result in failure of digital key authentication. The digital key system uses asymmetric cryptography to mutually authenticate vehicle-based computer system 100 and a device. The device reveals the identity of the device to known vehicles. Public keys are mutually exchanged through pairing of the owner device to the vehicle-based computer systems 100. The owner then authorizes the use of digital keys to friends and family members by signing their public keys. Applications include the verification of external devices and verification of vehicular components with OEM server 140. The digital key authentication occurs upon the successful connection of vehicle-based computer system 100 with OEM server 140. Corrupted cryptographic keys stored in secure storage 118 causes vehicle-based computer system 100 to failure to establish a secure connection with OEM server 140 which, in turn, prevents digital key service from functioning.

In some examples, corrupted cryptographic keys result in failure to access web applications from OEM server 140. The operation of OEM web apps on vehicle-based computer system 100 relies on a continuous connection with OEM server 140. Corrupted cryptographic keys stored in secure storage 118 causes vehicle-based computer system 100 to failure to establish a secure connection with OEM server 140. As a result, the operations of the OEM web apps are denied.

After the establishing a secure connection, vehicle-based computer system 100 and OEM server 140 send and receive messages using the secured connection. The corruption of the cryptographic keys stored in the vehicle's secure storage denies numerous safety, connectivity, entertainment, and/or security services to the connected vehicle. These cryptographic keys were generated during the manufacturing process by provisioning and storing the cryptographic keys into secure storage 118. On the basis of the cryptographic keys, a security certificate is generated by OEM server 140 and shared with vehicle-based computer system 100, where the security certificate is used for communication.

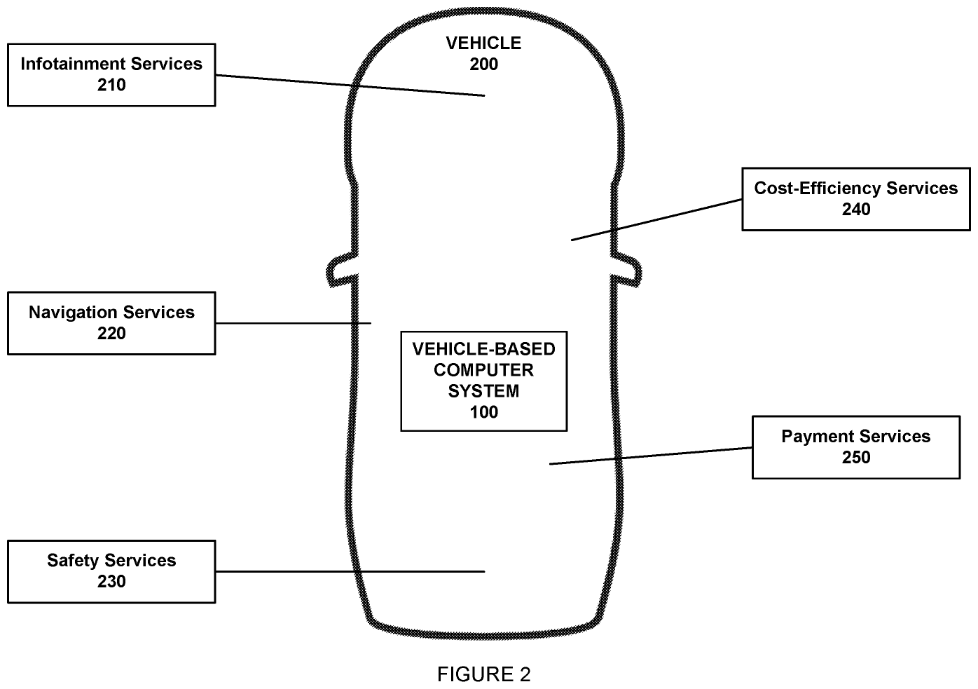

FIG. 2 illustrates various digital services that can be implemented by the vehicle-based computer system 100 of FIG. 1 according to one or more aspects of the various embodiments. As shown, vehicle-based computer system 100 provides various digital services to a vehicle 200. These digital services include, without limitation, infotainment services 210, navigation services 220, safety services 230, cost-efficiency services 240, and payment services 250. Infotainment services 210 include voice communications, personalized music, access to an automotive application (app) store or database, voice recognition, connected media services, zoned infotainment selection, and/or the like. Navigation services 220 include traffic information services, weather services, online route planning, and/or the like. Safety services 230 include smart SOS alerts, 911 emergency calling services, roadside assistance, and/or the like. Cost-efficiency services 240 include telematics data gathering for determining insurance coverage after an accident, remote diagnostics, condition-based maintenance alerts, vehicle software update services, and/or the like. Payment services 250 include electronic toll payment, reservation and payment for parking, and/or the like.

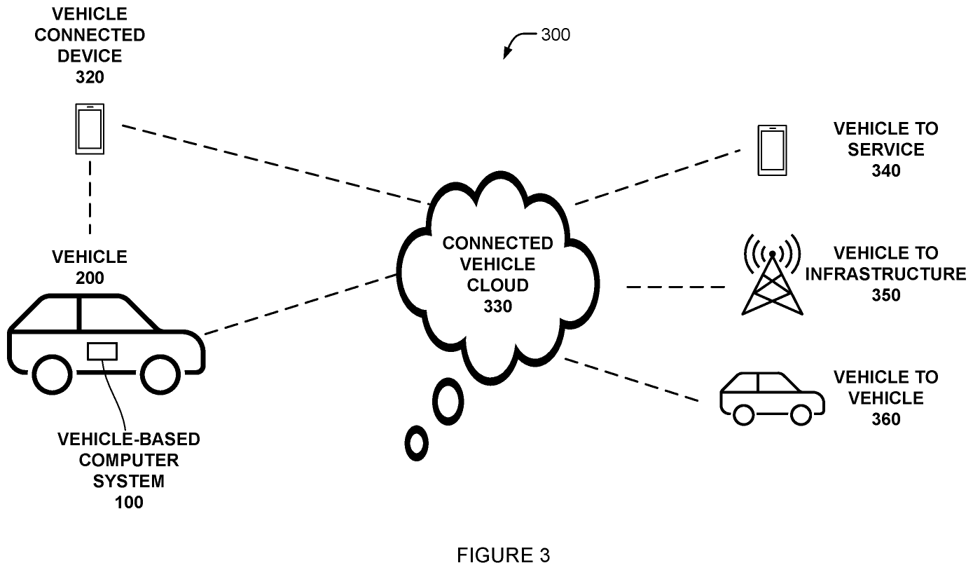

FIG. 3 is a block diagram of a cloud-based service network 300 for the vehicle-based computer system 100 of FIG. 1 according to one or more aspects of the various embodiments. Cloud-based service network 300 includes, without limitation, a vehicle that includes a vehicle-based computer system 100, as described herein. Cloud-based service network 300 further includes one or more vehicle connected devices 320, such as a mobile phone, a tablet computer, a laptop computer, and/or the like. Vehicle-based computer system 100 and vehicle connected device 320 communicate with each other over a wired communications interface and/or a wireless communications interface. Further, one or both of vehicle-based computer system 100 and vehicle connected device 320 communicate with other devices via a connected vehicle cloud infrastructure 330. Via connected vehicle cloud infrastructure 330, vehicle-based computer system 100 and/or vehicle connected device 320 provide various digital services, such as security and comfort services for the individual vehicle, vehicle traffic congestion and management services, autonomous driving features, and/or the like. Vehicle-based computer system 100 and/or vehicle connected device 320 further provide connections with various sensors 130, embedded devices, and/or the like that are linked to one or more networks via wired communications channels and/or wireless communications channels. In addition, vehicle-based computer system 100 and/or vehicle connected device 320 can continually collect and analyze large amounts of data from a vast array of data sources using a connected vehicle cloud infrastructure 330. In so doing, vehicle-based computer system 100 and/or vehicle connected device 320 often access cloud computing resources and big data processing systems when on the road.

In some examples, vehicle-based computer system 100 and/or vehicle connected device 320 communicate via connected vehicle cloud infrastructure 330 to implement a vehicle to service 340 communications channel, also referred to as a vehicle to everything (V2X) communications channel. Via vehicle to service 340 communications channel, vehicle-based computer system 100 and/or vehicle connected device 320 provide access to web applications, websites, data source, and other services available via the Internet.

In some examples, vehicle-based computer system 100 and/or vehicle connected device 320 communicate via connected vehicle cloud infrastructure 330 to implement a vehicle to infrastructure (V2I) 350 communications channel. Via vehicle to infrastructure 350 communications channel, vehicle-based computer system 100 and/or vehicle connected device 320 provide communications with sensors on street signs, on stoplights, at bus stops, and embedded in roads in order to acquire traffic updates and rerouting alerts. Further, via vehicle to infrastructure 350 communications channel, vehicle-based computer system 100 and/or vehicle connected device 320 can communicate with devices in the residence of the driver, devices in the office of the driver, smart devices, personal digital assistants, and/or the like. In this manner, vehicle-based computer system 100 and/or vehicle connected device 320 gather needed information and/or control devices in the residence, office, or other locations relevant to the driver.

In some examples, vehicle-based computer system 100 and/or vehicle connected device 320 communicate via connected vehicle cloud infrastructure 330 to implement a vehicle to vehicle (V2V) 360 communications channel. Via vehicle to vehicle 360 communications channel, vehicle-based computer system 100 and/or vehicle connected device 320 communicate with other nearby vehicles and exchange data with these vehicles. Vehicles communications between vehicles over vehicle to vehicle 360 communications channel enable vehicles to alert respective drivers to potential collision hazards and/or other hazards reported by other vehicles.

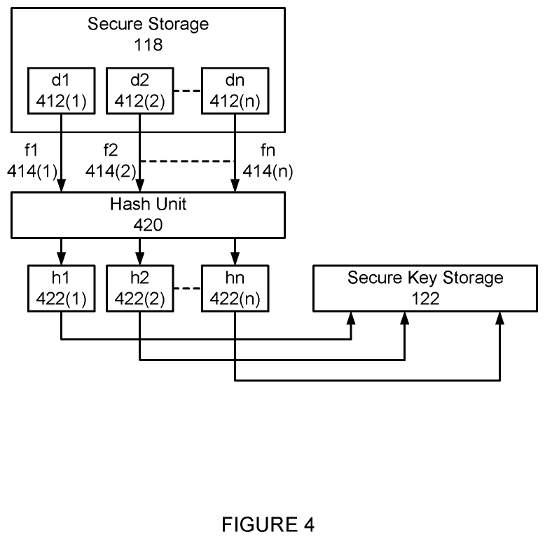

FIG. 4 is a block diagram of operations to install cryptographic keys in the secure storage 118 of the vehicle-based computer system 100 of FIG. 1 by a provisioning system based at a service center according to one or more aspects of the various embodiments. During provisioning at the manufacturing plant, an authorized service provider, or other service center, a processor at the service center stores secure data d1 412(1), d2 412(2), . . . dn 412(n) in the secure storage 118. The secure data stored in secure storage 118 includes private cryptographic keys, and other secure data, such as user profile data, instructions executed when operating in the trusted execution environment, data accessed when in the trusted execution environment, and/or the like. The processor organizes this data d1 412(1), d2 412(2), . . . dn 412(n) as files with filenames f1 414(1), f2 414(2), . . . fn 414(n), respectively. Subsequently, during operation of the vehicle 200, vehicle-based computer system 100 accesses the data d1 412(1), d2 412(2), . . . dn 412(n) through these filenames f1 414(1), f2 414(2), . . . fn 414(n) in order to access the private cryptographic keys along with other secure data.

A hash unit 420 performs a hash function on the data d1 412(1), d2 412(2), . . . dn 412(n) accessed through filenames f1 414(1), f2 414(2), . . . fn 414(n). Hash unit 420 can perform any technically feasible hash function that generates a hash value from a set of data. Hash unit 420 generates hash value h1 422(1) from the data d1 412(1) accessed through filename f1 414(1). Likewise, hash unit 420 generates hash value h2 422(2) from the data d2 412(2) accessed through filename f2 414(2). Hash unit 420 generates additional hash values, culminating by generating hash value hn 422(n) from the data dn 412(n) accessed through filename fn 414(n). Hash unit 420 stores the hash values h1 422(1), h2 422(2), . . . hn 422(n) in a secure key storage 122 in a memory system of vehicle-based computer system 100. The secure key storage 122 is located in a different location from the private cryptographic keys included the data d1 412(1), d2 412(2), . . . dn 412(n), such as another portion of secure storage 118, in a non-volatile memory included in processing unit 112, in a separate controller (not shown), and/or the like. The private cryptographic keys included in the data d1 412(1), d2 412(2), . . . dn 412(n) are considered the main cryptographic keys. The hash values h1 422(1), h2 422(2), . . . hn 422(n) stored in secure key storage 122 are used to verify whether the main cryptographic keys have been corrupted. If the main cryptographic keys have been corrupted, the secondary cryptographic keys, which are the emergency keys, are accessed in order to establish a secure connection with OEM server 140.

FIG. 5 is a block diagram of operations to recover corrupted cryptographic keys in the secure storage 118 of the vehicle-based computer system 100 of FIG. 1 by a key recovery system according to one or more aspects of the various embodiments. During normal vehicular operations, vehicle-based computer system 100 can attempt to perform a secure operation involving a cryptographic key, such as establishing a secure (e.g., a TLS) communications channel to communicate with OEM server 140 via a connected vehicle cloud infrastructure 330. In so doing, vehicle-based computer system 100 generates a cryptographic operations request 540 such as an encryption request, a decryption request, and/or the like. Any ECU or other relevant component associated with vehicle-based computer system 100 can generate the cryptographic operations request 540.

To complete the requested cryptographic operation request 540, vehicle-based computer system 100 generates a file request 550 to request access to a file with a filename of f(i) 514. In response, secure storage 118 reads data d(i) 512 representing the data included in the file with filename f(i) 514. Hash unit 520 generates a hash value H(i) 524 based on the data d(i) 512 read from secure storage 118. For example, if file request 550 requests filename f(1), then secure storage reads data d(1) and hash unit 520 generates hash value H(1). Likewise, if file request 550 requests filename f(2), then secure storage 118 reads data d(2) and hash unit 520 generates hash value H(2). If the cryptographic keys and other data stored in secure storage 118 have not been corrupted, then hash unit 520 generates the same hash values as hash unit 420 generated during provisioning.

Vehicle-based computer system 100 accesses secure key storage 122 to retrieve hash value h(i) 522 corresponding to the hash value H(i) 524 generated by hash unit 520. Comparator 560 compares retrieved hash value h(i) 522 with the hash value H(i) 524 generated by hash unit 520. For example, if hash unit 520 generated hash value H(1), then comparator 560 compares generated hash value H(1) with retrieved hash value h(1). If comparator 560 determines that the generated hash value H(1) is different than the previously stored and retrieved hash value h(1), then vehicle-based computer system 100 determines that secure storage 118 is corrupted 562, because data d(1) used to generate hash value H(1) is different than the data d(1) stored during the provisioning process of FIG. 4. If comparator 560 determines that the generated hash value H(1) is the same as the previously stored and retrieved hash value h(1), then vehicle-based computer system 100 determines that secure storage 118 is not corrupted 564.

Likewise, if hash unit 520 generated hash value H(2), then comparator 560 compares generated hash value H(2) with retrieved hash value h(2). If comparator 560 determines that the generated hash value H(2) is different than the previously stored and retrieved hash value h(2), then vehicle-based computer system 100 determines that secure storage 118 is corrupted 562, because data d(2) used to generate hash value H(2) is different than the data d(2) stored during the provisioning process of FIG. 4. Vehicle-based computer system 100 then uses a limited emergency service to recover and restore the corrupted cryptographic keys for the vehicle 200 (e.g., by using method 700, described below). Vehicle-based computer system 100 restores the corrupted cryptographic keys by receiving a replacement key from OEM server 140 and storing the replacement key in secure storage 118, secure key storage 122, and/or like. If comparator 560 determines that the generated hash value H(2) is the same as the previously stored and retrieved hash value h(2), then vehicle-based computer system 100 determines that secure storage 118 is not corrupted 564. Vehicle-based computer system 100 then completes the cryptographic operations request 540. In some examples, completing the cryptographic operations request 540 establishes or maintains a secure connection with OEM server 140 to provide various digital services for the vehicle 200 as described herein.

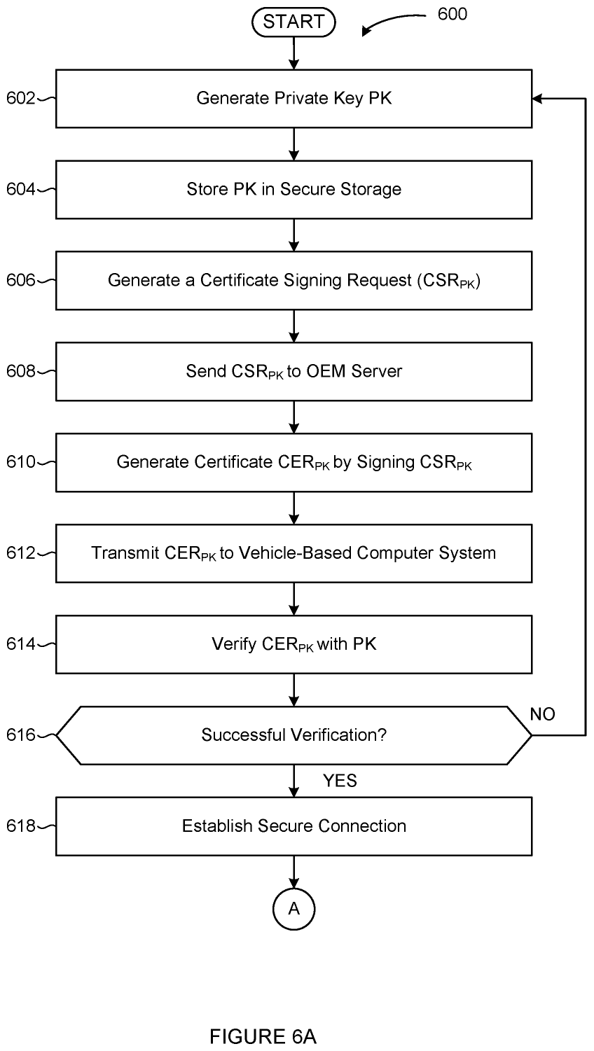

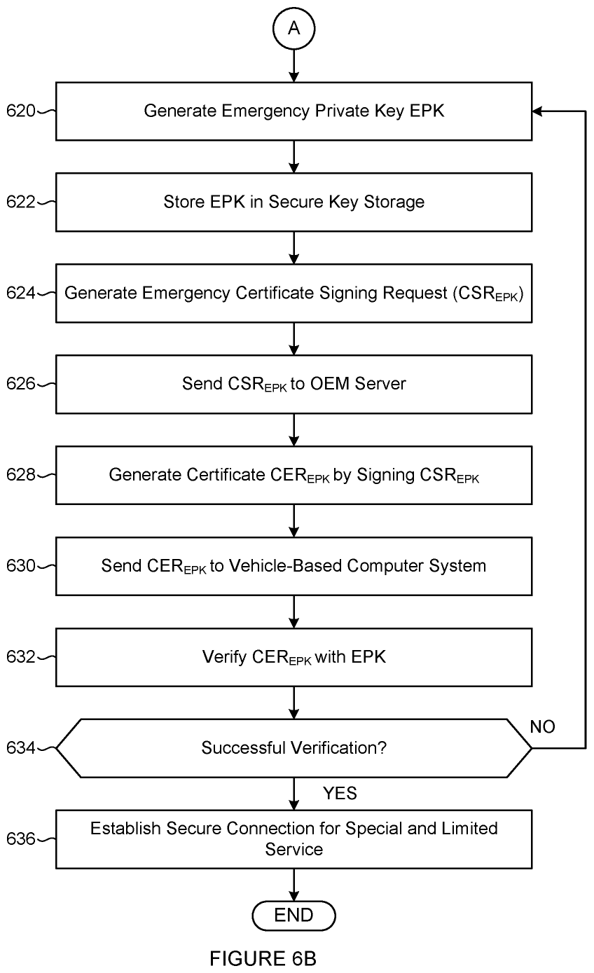

FIGS. 6A-6B set forth a flow diagram of method steps for provisioning cryptographic keys in the secure storage of the vehicle-based computer system of FIG. 1 according to one or more aspects of the various embodiments. Although the method steps are described in conjunction with the systems and operations of FIGS. 1-5, persons skilled in the art will understand that any system configured to perform the method steps, in any order, is within the scope of the present disclosure.

As shown, a method 600 begins at step 602, where a vehicle-based computer system 100 generates a private cryptographic key PK in a trusted execution environment. The disclosed embodiments employ two cryptographic keys: a main cryptographic key and a secondary cryptographic key. Both the main cryptographic key and the secondary cryptographic key are provisioned and installed into computing device 110 during manufacturing of the vehicle-based computer system 100. During normal operation, control application 115 accesses the main cryptographic key is stored in secure storage 118 in order to initiate and maintain communications with OEM server 140 and to provide digital services for the vehicle. In some examples, vehicle-based computer system 100 generates the cryptographic keys and stores the cryptographic keys in secure storage 118 by using the operations consistent with those described in conjunction with FIG. 4.

At step 604, vehicle-based computer system 100 stores the generated private cryptographic key PK in secure storage 118. The main cryptographic key is stored in secure storage 118. The secondary cryptographic key is stored in a different location, such as another portion of secure storage 118, in a non-volatile memory included in processing unit 112, in a separate controller (not shown), and/or the like. This secondary cryptographic key is considered as an emergency key.

In some examples, secure storage 118 is implemented on a standard file system and secure storage 118 is enabled at compile time. In some examples, secure storage 118 is implemented as an RPMB partition of an embedded memory system. The RPMB protocol enables a device to store secure data in a confined, specific area of secure storage 118 that is authenticated and protected against replay attack. RPMB can be implemented in automotive engine control units (ECUs) and related controllers using flash storage technology such as eMMC, universal flash storage (UFS), non-volatile memory express (NVMe), and/or the like.

At step 606, vehicle-based computer system 100 uses the generated private cryptographic key PK to generate a corresponding certificate signing request CSRPK. The cryptographic keys PK are used for security certificate verifications for the successful establishment of a secure (e.g., a TLS) connection between processing unit 112 and OEM server 140. To initiate the security certificate verifications, vehicle-based computer system 100 transmits a request to sign a security certificate.

At step 608, vehicle-based computer system 100 transmits the certificate signing request CSRPK to an OEM server 140 via a connected vehicle cloud infrastructure 330. In operation, vehicle-based computer system 100 accesses OEM server 140 via the connected vehicle cloud infrastructure 330 to provide safety, security, entertainment, and communication related digital services to the vehicle 200 in real-time. This vehicular connection between vehicle-based computer system 100 and OEM server 140 is established through a secure connection.

At step 610, OEM server 140 generates a security certificate CERPK by signing the certificate signing request CSRPK received from vehicle-based computer system 100. The signed certificate signing request CSRPK authorizes vehicle-based computer system 100 to provide the corresponding digital services to the vehicle 200.

At step 612, OEM server 140 transmits the signed security certificate CERPK to vehicle-based computer system 100. OEM server 140 transmits this signed security certificate CERPK to vehicle-based computer system 100 via the connected vehicle cloud infrastructure 330.

At step 614, vehicle-based computer system 100 verifies the received signed security certificate CERPK using the private cryptographic key PK in secure storage 118. This verification is a test of the newly provisioned private cryptographic key PK to determine that the private cryptographic key PK is compatible with the received signed security certificate CERPK.

At step 616, vehicle-based computer system 100 determines whether secure storage 118 is corrupted based on whether the verification performed at step 614 was successful. If vehicle-based computer system 100 determines that verification was not successful, then the method 600 proceeds to step 602, described above, to generate another private key and perform another verification operation. If, on the other hand, vehicle-based computer system 100 determines that verification was successful, then the method 600 proceeds to step 618, where vehicle-based computer system 100 establishes a secure connection. If the private cryptographic key PK is not corrupted, then vehicle-based computer system 100 establishes a successful secure connection with OEM server 140.

At step 620, vehicle-based computer system 100 generates an emergency private cryptographic key EPK in a trusted execution environment. During emergency operation, key recovery application 116 generates the emergency private cryptographic key EPK in order to recover and restore communications with OEM server 140 and to restore digital services for the vehicle. In some examples, the emergency private cryptographic key EPK is a duplicate copy of, and therefore is the same as, the private cryptographic key PK generated at step 602. In some examples, the emergency private cryptographic key EPK is different from the private cryptographic key PK generated at step 602.

At step 622, vehicle-based computer system 100 stores the emergency private cryptographic key EPK in secure key storage 122. Secure key storage 122 is located in a non-volatile memory included in processing unit 112, in a separate controller (not shown), and/or the like. In some examples, secure key storage 122 is included in another portion of secure storage 118 that is isolated from the portion of secure storage 118 that stores the main cryptographic keys

At step 624, vehicle-based computer system 100 uses the generated emergency private cryptographic key EPK to generate a corresponding emergency certificate signing request CSREPK. The emergency cryptographic key EPK is used for emergency security certificate verifications. The emergency security certificate verifications are used for the successful establishment of the secure connection between processing unit 112 and OEM server 140 in order to recover corrupted cryptographic keys. To initiate the emergency security certificate verifications, vehicle-based computer system 100 transmits a request to sign an emergency security certificate.

At step 626, vehicle-based computer system 100 transmits the emergency certificate signing request CSREPK to OEM server 140. Vehicle-based computer system 100 transmits this emergency certificate signing request CSREPK to OEM server 140 via the connected vehicle cloud infrastructure 330.

At step 628, OEM server 140 generates an emergency security certificate CEREPK by signing the emergency certificate signing request CSREPK received from vehicle-based computer system 100. The signed emergency security certificate CEREPK authorizes vehicle-based computer system 100 to provide a special and limited emergency service to recover and restore corrupted cryptographic keys for the vehicle 200.

At step 630, OEM server 140 transmits the signed emergency security certificate CEREPK to vehicle-based computer system 100. OEM server 140 transmits this signed emergency security certificate CEREPK to vehicle-based computer system 100 via the connected vehicle cloud infrastructure 330.

At step 632, vehicle-based computer system 100 verifies the received signed emergency security certificate CEREPK using the emergency private cryptographic key EPK in secure storage 118. Any corruption of secure storage 118, either due to security breaches or other activities, can result in the emergency cryptographic keys becoming inaccessible or having a modified value. This condition results in a corrupted emergency cryptographic key in secure storage 118. Such emergency cryptographic key corruption can result in failure of security certificate verifications.

At step 634, vehicle-based computer system 100 determines whether the emergency cryptographic key is corrupted based on whether the verification performed at step 632 was successful. If vehicle-based computer system 100 determines that verification was not successful, then the method 600 proceeds to step 620, described above, to generate another emergency private key and perform another verification operation. If, on the other hand, vehicle-based computer system 100 determines that verification was successful, then the method 600 proceeds to step 636.

At step 636, after verifying the received signed emergency security certificate CEREPK, vehicle-based computer system 100 establishes a successful secure connection with OEM server 140 for a limited emergency service. Vehicle-based computer system 100 uses this limited emergency service to recover and restore corrupted cryptographic keys for the vehicle 200 (e.g., by using method 700, described below). The method 600 then terminates.

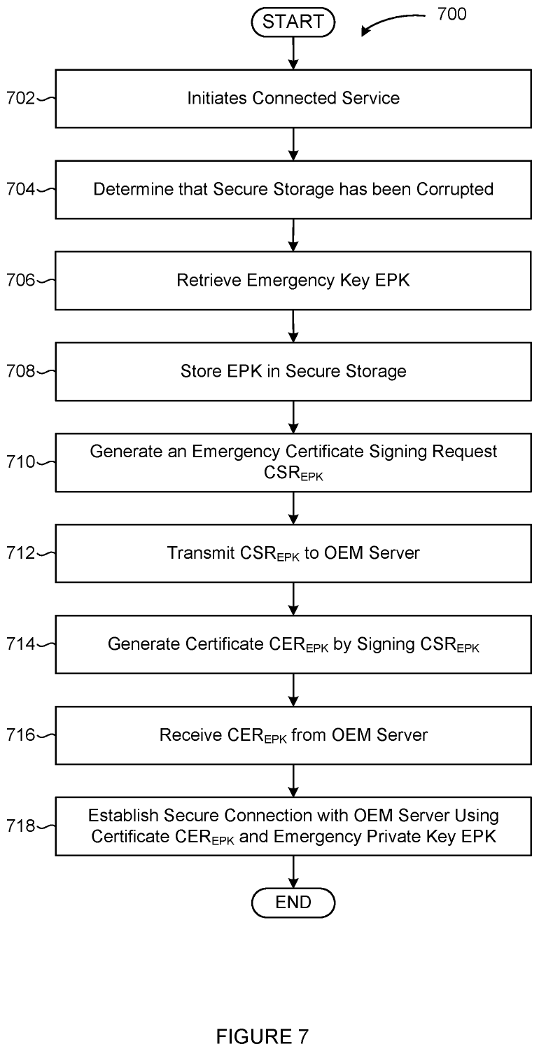

FIG. 7 is a flow diagram of method steps for recovering corrupted cryptographic keys in the secure storage of the vehicle-based computer system of FIG. 1 according to one or more aspects of the various embodiments. Although the method steps are described in conjunction with the systems and operations of FIGS. 1-5, persons skilled in the art will understand that any system configured to perform the method steps, in any order, is within the scope of the present disclosure.

As shown, a method 700 begins at step 702, where a vehicle-based computer system 100 initiates a connected service for a vehicle 200. Vehicle-based computer system 100 can implement the connected service in the context of a vehicle digital cockpit, a head unit, an ADAS, an ECU, and/or other component included in a vehicle. The connected service provides various digital services for the vehicle including infotainment services 210, navigation services 220, safety services 230, cost-efficiency services 240, payment services 250, and/or the like.

At step 704, vehicle-based computer system 100 detects that secure storage 118 is corrupted. Either when the connected service begins execution and/or at any time during the execution of the connected service, vehicle-based computer system 100 can request a cryptographic operation. The cryptographic operation authorizes vehicle-based computer system 100 to perform one or more operations on behalf of the connected service. Before performing the cryptographic operation, vehicle-based computer system 100 determines whether secure storage 118 has been corrupted. Such a corruption indicates an unintentional or malicious corruption of a corresponding private cryptographic key associated with the connected service.

In some examples, vehicle-based computer system 100 detects that secure storage 118 is corrupted by using the operations described in conjunction with FIG. 5. If a private cryptographic key PK stored in secure storage 118 is corrupted, then vehicle-based computer system 100 fails to establish a secure connection, such as with OEM server 140. Failure to verify a security certificate can lead to a failure to establish a secure connection between processing unit 112 and OEM server 140, resulting in the denial of digital services. Consequently, the vehicle is no longer able to supply these digital services. As a result, vehicle-based computer system 100 executes key recovery application 116. Key recovery application 116, in turn, invokes and executes an emergency service or an emergency session in a trusted execution environment in order to reestablish a secure connection with OEM server 140. During operation of the emergency service, key recovery application 116 accesses the secondary cryptographic key in order to recover and restore communications with OEM server 140. The key recovery application 116 employs an automated key recovery technique that recovers the corrupted cryptographic keys stored in secure storage 118 using a software update process in the form of an emergency key recovery service. The key recovery application 116 also restores digital services for the vehicle.

At step 706, vehicle-based computer system 100 executes the emergency session to access a secondary cryptographic key that serves as an emergency key. In some examples, vehicle-based computer system 100 executes the emergency service to retrieve the emergency key from secure key storage 122 and to transfer the emergency key to secure storage 118 to be used as the main private cryptographic key. The key recovery technique of the emergency service employs two cryptographic keys. The main cryptographic key is stored in secure storage 118. The secondary cryptographic key is stored in secure key storage 122 in a different location from the main cryptographic key, such as another portion of secure storage 118, in a non-volatile memory included in processing unit 112, in a separate controller, and/or the like. This secondary cryptographic key is considered as an emergency key. Both the main cryptographic key and the secondary cryptographic key are provisioned and installed into computing device 110 during manufacturing of the vehicle-based computer system 100, such as by using method 600. During normal operation, control application 115 accesses the main cryptographic key is stored in secure storage 118 in order to initiate and maintain communications with OEM server 140 and to provide digital services for the vehicle. If control application 115 determines that the main cryptographic key stored in secure storage 118 has been corrupted, then key recovery application 116 accesses the secondary cryptographic key as an emergency key to establish a secure (e.g., a TLS) connection for emergency services between processing unit 112 and OEM server 140. In some examples, vehicle-based computer system 100 replaces the corrupted main cryptographic key stored in secure storage 118 with the emergency key retrieved from secure key storage 122. Via the emergency service, key recovery application 116 recovers the emergency key from secure key storage 122 and restores the corrupted main cryptographic key in secure storage 118, During the emergency session, key recovery application 116 uses the emergency private cryptographic key EPK to restore communications with OEM server 140 and to restore digital services for the vehicle. In some examples, vehicle-based computer system 100 uses the emergency service to recover and restore the corrupted main cryptographic keys.

At step 708, vehicle-based computer system 100 executes the emergency session to store the emergency private cryptographic key EPK in secure storage 118. Secure storage 118 is implemented on a standard file system and secure storage 118 is enabled at compile time. In some examples, secure storage 118 is implemented as an RPMB partition of an embedded memory system. The RPMB protocol enables a device to store secure data in a confined, specific area of secure storage 118 that is authenticated and protected against replay attack.

At step 710, vehicle-based computer system 100 executes the emergency session to use the generated emergency private cryptographic key EPK to generate a corresponding emergency certificate signing request CSREPK. The emergency cryptographic key EPK is used for emergency security certificate verifications. The emergency security certificate verifications are used for the successful establishment of the secure connection between processing unit 112 and OEM server 140 in order to recover corrupted cryptographic keys. To initiate the emergency security certificate verifications, vehicle-based computer system 100 transmits a request to sign an emergency security certificate.

At step 712, vehicle-based computer system 100 executes the emergency session to transmit the emergency certificate signing request CSREPK to OEM server 140. Vehicle-based computer system 100 transmits this emergency certificate signing request CSREPK to OEM server 140 via the connected vehicle cloud infrastructure 330.

At step 714, OEM server 140 generates an emergency security certificate CEREPK by signing the emergency certificate signing request CSREPK received from vehicle-based computer system 100. The signed emergency security certificate CEREPK authorizes vehicle-based computer system 100 to establish a secure connection with OEM server 140. OEM server 140 transmits the signed emergency security certificate CEREPK to vehicle-based computer system 100.

At step 716, vehicle-based computer system 100 receives the signed emergency security certificate CEREPK from OEM server 140. Vehicle-based computer system 100 then terminates the emergency service. After vehicle-based computer system 100 receives the emergency security certificate CEREPK, vehicle-based computer system 100 is authorized to establish a secure connection with OEM server 140. As a result, the emergency service is no longer needed.

At step 718, using the emergency private cryptographic key EPK and the received signed emergency security certificate CEREPK, vehicle-based computer system 100 establishes a secure connection with OEM server 140 for all available digital services. establishes a secure connection with OEM server 140 and restores the interrupted digital services. Vehicle-based computer system 100 restores the digital services that were interrupted as a result of the corrupted main cryptographic key. By using the emergency service, vehicle-based computer system 100 can restore the corrupted main cryptographic keys and again communicate with OEM server 140 over a secure connection. As a result, vehicle-based computer system 100 is able to restore digital services to the vehicle 200 after a cryptographic key is corrupted and without having to bring the vehicle 200 to a service center for reprovision of the cryptographic keys. The method 700 then terminates.

In sum, the disclosed embodiments are directed to a vehicle-based computer system that provides advanced features for a vehicle. These advanced features are enabled by using cryptographic keys to protect the advanced features from prevent unintentional interference and malicious cyberattacks. Corruption of the cryptographic keys indicates that the advanced features have been compromised. With the disclosed approach, after a cryptographic key has been determined to be corrupted, the vehicle-based computer system can retrieve an emergency cryptographic key. The vehicle-based computer system uses the emergency cryptographic key to establish a secure emergency connection with the network. Via the secure emergency connection can recover the corrupted cryptographic key and restore the advanced features without having to return the vehicle to a service center.

At least one technical advantage of the disclosed techniques relative to the prior art is that, with the disclosed techniques, a vehicle in the field can restore corrupted cryptographic keys stored in the secure storage system of the vehicle. The vehicle can restore the corrupted cryptographic keys without returning the vehicle to the manufacturing plant, an authorized service provider, or other service center. As a result, service centers do not need to reserve shop capacity to restore corrupted cryptographic keys. Further, drivers and owners can reduce the time and number of service calls for their vehicles. The disclosed embodiments thereby present techniques to perform recovery of cryptographic keys resulting from a corrupted secure storage without recalling the vehicles back into the service center. By avoiding recall of vehicles with corrupted cryptographic keys, the disclosed techniques reduce the time and financial burden of service centers and of drivers and owners of affected vehicles. These advantages represent one or more technological improvements over prior art approaches.

1. In some embodiments, a method for recovering a cryptographic key comprises: determining that the cryptographic key stored in a first secure storage is corrupted; retrieving an emergency key from a second secure storage; and establishing communications with a server by using the emergency key.

2. The method according to clause 1, wherein the second secure storage is located in a controller that is separate from a computing device that includes the first secure storage.

3. The method according to clause 1 or clause 2, further comprising, subsequent to establishing communications with the server by using the emergency key: receiving a replacement key from the server; and replacing the cryptographic key with the replacement key.

4. The method according to any of clauses 1-3, further comprising: subsequent to determining that the cryptographic key stored in the first secure storage is corrupted, invoking an emergency service that retrieves the emergency key from the second secure storage; and subsequent to establishing communications with the server, terminating the emergency service.

5. The method according to any of clauses 1-4, further comprising: generating, via the emergency key, an emergency certificate signing request; transmitting the emergency certificate signing request to the server; receiving, from the server, a signed emergency certificate; and communicating with the server by using the emergency key and the signed emergency certificate.

6. The method according to any of clauses 1-5, wherein determining that the cryptographic key is corrupted comprises: determining a first hash value computed from data included in the first secure storage, wherein the data includes the cryptographic key; comparing the first hash value to a second hash value that was previously computed from the data included in the first secure storage; and determining that the first hash value is not equal to the second hash value.

7. The method according to any of clauses 1-6, further comprising using the emergency key to perform an operation related to a digital service provided by the server.

8. The method according to any of clauses 1-7, wherein the first secure storage includes a replay protected memory block.

9. In some embodiments, one or more non-transitory computer-readable media store program instructions that, when executed by one or more processors, cause the one or more processors to perform steps of: determining that a cryptographic key stored in a first secure storage is corrupted; retrieving an emergency key from a second secure storage; and establishing communications with a server by using the emergency key.

10. The one or more non-transitory computer-readable media according to clause 9, wherein the second secure storage is located in a controller that is separate from the one or more processors.

11. The one or more non-transitory computer-readable media according to clause 9 or clause 10, further comprising, subsequent to establishing communications with the server by using the emergency key: receiving a replacement key from the server; and replacing the cryptographic key with the replacement key.

12. The one or more non-transitory computer-readable media according to any of clauses 9-11, further comprising: subsequent to determining that the cryptographic key stored in the first secure storage is corrupted, invoking an emergency service that retrieves the emergency key from the second secure storage; and subsequent to establishing communications with the server, terminating the emergency service.

13. The one or more non-transitory computer-readable media according to any of clauses 9-12, further comprising: generating, via the emergency key, an emergency certificate signing request; transmitting the emergency certificate signing request to the server; receiving, from the server, a signed emergency certificate; and communicating with the server by using the emergency key and the signed emergency certificate.

14. The one or more non-transitory computer-readable media according to any of clauses 9-13, wherein determining that the cryptographic key is corrupted comprises: determining a first hash value computed from data included in the first secure storage, wherein the data includes the cryptographic key; comparing the first hash value to a second hash value that was previously computed from the data included in the first secure storage; and determining that the first hash value is not equal to the second hash value.

15. The one or more non-transitory computer-readable media according to any of clauses 9-14, further comprising using the emergency key to perform an operation related to a digital service provided by the server.

16. The one or more non-transitory computer-readable media according to any of clauses 9-15, wherein the first secure storage includes a replay protected memory block.

17. In some embodiments, a system embedded in a vehicle comprises: one or more memories storing instructions; and one or more processors coupled to the one or more memories and, when executing the instructions: determine that a cryptographic key stored in a first secure storage is corrupted; retrieve an emergency key from a second secure storage; and establish communications with a server by using the emergency key.

18. The system according to clause 17, wherein the second secure storage is located in a controller that is separate from the one or more processors.

19. The system according to clause 17 or clause 18, wherein the one or more processors further, subsequent to establishing communications with the server by using the emergency key: receive a replacement key from the server; and replace the cryptographic key with the replacement key.

20. The system according to any of clauses 17-19, wherein the one or more processors further: subsequent to determining that the cryptographic key stored in the first secure storage is corrupted, invoke an emergency service that retrieves the emergency key from the second secure storage; and subsequent to establishing communications with the server, terminate the emergency service.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for recovering a cryptographic key, comprising:
determining that the cryptographic key stored in a first secure storage is corrupted;
retrieving an emergency key from a second secure storage; and
establishing communications with a server by using the emergency key.

2. The method of claim 1, wherein the second secure storage is located in a controller that is separate from a computing device that includes the first secure storage.

3. The method of claim 1, further comprising, subsequent to establishing communications with the server by using the emergency key:
receiving a replacement key from the server; and
replacing the cryptographic key with the replacement key.

4. The method of claim 1, further comprising:
subsequent to determining that the cryptographic key stored in the first secure storage is corrupted, invoking an emergency service that retrieves the emergency key from the second secure storage; and
subsequent to establishing communications with the server, terminating the emergency service.

5. The method of claim 1, further comprising:
generating, via the emergency key, an emergency certificate signing request;
transmitting the emergency certificate signing request to the server;
receiving, from the server, a signed emergency certificate; and
communicating with the server by using the emergency key and the signed emergency certificate.

6. The method of claim 1, wherein determining that the cryptographic key is corrupted comprises:
determining a first hash value computed from data included in the first secure storage, wherein the data includes the cryptographic key;
comparing the first hash value to a second hash value that was previously computed from the data included in the first secure storage; and
determining that the first hash value is not equal to the second hash value.

7. The method of claim 1, further comprising using the emergency key to perform an operation related to a digital service provided by the server.

8. The method of claim 1, wherein the first secure storage includes a replay protected memory block.

9. One or more non-transitory computer-readable media storing program instructions that, when executed by one or more processors, cause the one or more processors to perform steps of:
determining that a cryptographic key stored in a first secure storage is corrupted;
retrieving an emergency key from a second secure storage; and
establishing communications with a server by using the emergency key.

10. The one or more non-transitory computer-readable media of claim 9, wherein the second secure storage is located in a controller that is separate from the one or more processors.

11. The one or more non-transitory computer-readable media of claim 9, further comprising, subsequent to establishing communications with the server by using the emergency key:
receiving a replacement key from the server; and
replacing the cryptographic key with the replacement key.

12. The one or more non-transitory computer-readable media of claim 9, further comprising:
subsequent to determining that the cryptographic key stored in the first secure storage is corrupted, invoking an emergency service that retrieves the emergency key from the second secure storage; and
subsequent to establishing communications with the server, terminating the emergency service.

13. The one or more non-transitory computer-readable media of claim 9, further comprising:
generating, via the emergency key, an emergency certificate signing request;
transmitting the emergency certificate signing request to the server;
receiving, from the server, a signed emergency certificate; and
communicating with the server by using the emergency key and the signed emergency certificate.

14. The one or more non-transitory computer-readable media of claim 9, wherein determining that the cryptographic key is corrupted comprises:
determining a first hash value computed from data included in the first secure storage, wherein the data includes the cryptographic key;
comparing the first hash value to a second hash value that was previously computed from the data included in the first secure storage; and
determining that the first hash value is not equal to the second hash value.

15. The one or more non-transitory computer-readable media of claim 9, further comprising using the emergency key to perform an operation related to a digital service provided by the server.

16. The one or more non-transitory computer-readable media of claim 9, wherein the first secure storage includes a replay protected memory block.

17. A system embedded in a vehicle, comprising:
one or more memories storing instructions; and
one or more processors coupled to the one or more memories and, when executing the instructions:
determine that a cryptographic key stored in a first secure storage is corrupted;
retrieve an emergency key from a second secure storage; and
establish communications with a server by using the emergency key.

18. The system of claim 17, wherein the second secure storage is located in a controller that is separate from the one or more processors.

19. The system of claim 17, wherein the one or more processors further, subsequent to establishing communications with the server by using the emergency key:
receive a replacement key from the server; and
replace the cryptographic key with the replacement key.

20. The system of claim 17, wherein the one or more processors further:
subsequent to determining that the cryptographic key stored in the first secure storage is corrupted, invoke an emergency service that retrieves the emergency key from the second secure storage; and
subsequent to establishing communications with the server, terminate the emergency service.
